(19) United States
(12) Patent Application Publication
(10) Pub. No.: US 2003/0075241 A1
(43) Pub. Date: Apr. 24, 2003

(54) Coupling system for transferring a volatile liquid

(75) Inventor: Petter Videbrink, Upplands Vasby (SE)

Correspondence Address: SCHIFF HARDIN & WAITE, 6600 SEARS TOWER, 233 S WACKER DR, CHICAGO, IL, 60606-6473, US

(73) Assignee: Siemens-Elema AB

(21) Appl. No.: 10/259,009

(22) Filed: Sep. 27, 2002

(30) Foreign Application Priority Data
Oct. 18, 2001 (SE) 0103473-5

(51) Int. Cl. B67C 3/00; B65B 3/00; B65B 1/04

(52) U.S. Cl. 141/351

(57) ABSTRACT

A coupling system for transferring liquid anaesthetic from a bottle to a vaporizer has a first part, having a first valve with a first spring-loaded valve body and a first counter body, and a second valve part, having in the corresponding fashion a second valve with a second spring-loaded valve body and a second counter body, the first part and the second part being interconnectable. The first counter body is devised to act on the second spring-loaded valve body in an opening direction, and the second counter body is devised to act on the first spring-loaded valve body in an opening direction to form a path of flow for the liquid anaesthetic. Leakage of liquid into atmosphere is reduced since the first spring-loaded valve body and the first counter body are arranged so they, in a closed position, form an essentially flat first surface, and the second spring-loaded valve body and the second counter body are arranged in the corresponding way so they, in the closed position, form an essentially flat second surface.

### BACKGROUND OF THE INVENTION

1. Field of the Invention

The present invention relates to a coupling system for transferring a volatile liquid, such as for transferring liquid anaesthetic from a bottle to a vaporizer.

2. Description of the Prior Art

In inhalation anaesthesia, a gas mixture containing an anaesthetic is supplied to a patient via the airways. The anaesthetic is usually a liquid contained in a vaporizer, and a specific amount of liquid is vaporized, as needed, for delivery to the patient. The vaporizer holds a limited amount of liquid and may need refilling during ongoing anaesthesia.

When the vaporizer is refilled with liquid, keeping the anaesthetic from leaking into the surroundings and vaporizing into the atmosphere is important. There are two reasons for this. The anaesthetic agent's adverse impact on staff during ongoing surgery is one short-term effect. A long-term effect is that staff exposed to anaesthetic gases for a long time can develop cancer.

A number of coupling systems are known for replenishing liquid anaesthetic in a vaporizer. Some of the systems are made of two parts, one on the bottle holding the liquid and one on the vaporizer. Both these parts contain a moving, spring-loaded valve body and a counter body. When the parts are interconnected, the counter body in the respective part acts on the valve body in the other part to form a path of flow for the liquid. One common disadvantage with these coupling systems is the presence of residual anaesthetic when the parts are separated, and this liquid evaporates into atmosphere.

Known coupling systems are disclosed in e.g. PCT Application No. WO92/12753.

In another known type of vaporizer, the bottle holding the liquid anaesthetic for storage is used as a container for the anaesthetic in the vaporizer, and, in principle, only the amount of liquid to be vaporized is transferred to the vaporizer. Even here, the same problem of residual liquid exists when the bottle is detached from the vaporizer.

### SUMMARY OF THE INVENTION

An object of the present invention is to provide a coupling system for transferring liquid anaesthetic from a bottle to a vaporizer, wherein the problems encountered in the prior art technology are at least alleviated.

The above object is achieved in accordance with the principles of the present invention in a coupling system for transferring a volatile liquid, such as liquid anaesthetic, from a bottle to an apparatus wherein the liquid is to be utilized, the coupling system having a first part with a first valve with a first spring-loaded valve body and a first counter-body, and a second part having a second valve with a second spring-loaded valve body and a second counter-body. The first part and the second part are interconnectable, with the first counter-body acting on the second spring-loaded valve body in an opening direction, and the second counter-body acting on the first spring-loaded valve body in an opening direction, to form a flow path for the liquid. The first spring-loaded valve body and the first counter-body in a closed position form a substantially flat first surface, and the second spring-loaded valve body and the second counter-body in a closed position form a substantially flat second surface.

Fluid spillage is reduced to a minimum when the coupling system is devised in two parts so the spring-loaded valve body and the counter body in the respective part form an essentially flat surface. In principle, there is no space between parts in which fluid can accumulate.

Even if the respective valve body is simultaneously actuated in the opening direction, the parts are devised so the passage for the flow of liquid (and gas) opens in one of the parts first. The vaporizer part should open first and close last when the parts are interconnected or detached during sequential opening of the flow passage.

An additional gasket arranged on one of the parts to seal against the other part before the valve bodies are affected also reduces the risk of gas leakage from the coupling system.

One of the parts can be permanently mounted on the vaporizer, whereas the other part can be permanently mounted on a bottle or can be an adapter suitable for mounting on a bottle.

### DESCRIPTION OF THE DRAWINGS

FIG. 1 is a schematic illustration of a first part in the inventive coupling system.

FIG. 2 is a schematic illustration of a second part in the inventive coupling system.

### DESCRIPTION OF THE PREFERRED EMBODIMENTS

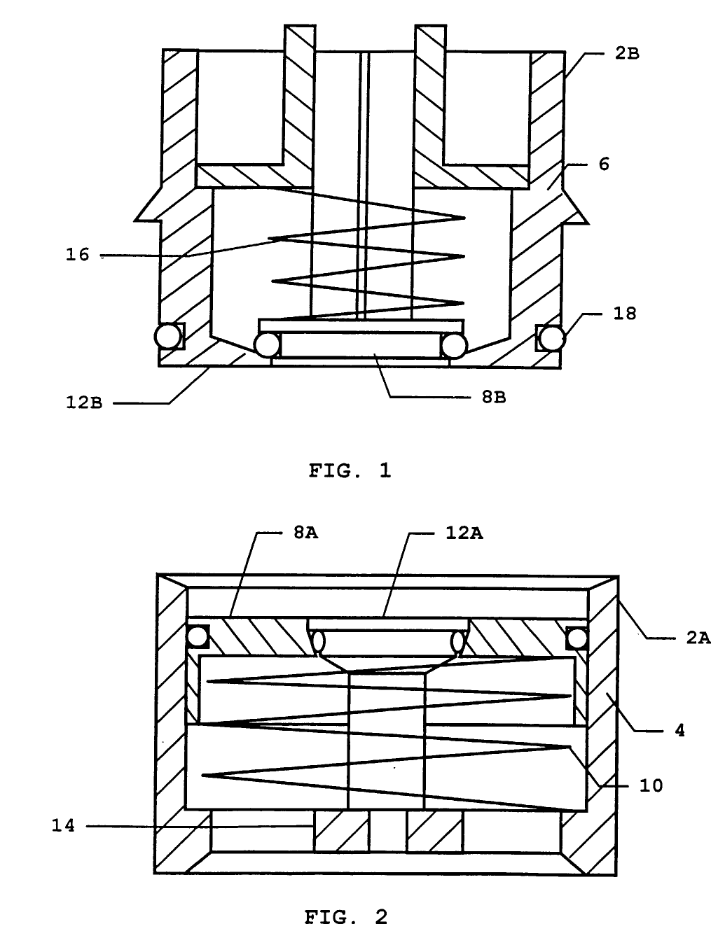

Reference is simultaneously made below to both FIG. 1 and FIG. 2. They illustrate the two parts in the embodiment of the coupling system according to the invention.

The first part 2A is connectable to a second part 2B. In this embodiment, the first part 2A is connected to a vaporizer (not shown), and the second part 2B is connected to or is part of a bottle (not shown) containing liquid anaesthetic.

The first part 2A has a cylindrical casing 4 with an internal diameter tailored to the external diameter of a casing 6 for the second part 2B.

The first part 2A has a first valve body 8A that is biased against a closed position by a first spring 10. In principle, the first valve body 8A has a circular cross-section surrounding a centrally located first counter body 12A. The first counter body 12A rests on a part 14 of the casing 4. The first valve body 8A and the first counter body 12A are devised to form an essentially flat first surface.

In the corresponding manner, the second part 2B has a valve body 8B biased in a closed position by a second spring 16 and a second counter body 12B. The second counter body 12B is formed by the outer part of the casing 6. The second valve body 8B and the second counter body 12B are also devised to form an essentially flat second surface.

In use, the parts 2A, 2B are conjoined by inserting the second part 2B into the first part 2A. Before the flat surfaces touch, a gasket 18 in the second part 2B seals against the inner surface of the casing 4 of the first part's 2A casing 4 and ensures that no liquid or gas is able to leak out of the coupling system once a passage for liquid is established.

When the parts 2A, 2B, are pushed further together, the first counter body 12A begins to press the second valve body 8B against the closing force of the second spring 16 and opens a passage for liquid from the bottle. At the same time, the second counter body 12B presses the first valve body 8A against the closing force of the first spring 10 and opens a passage for liquid into the vaporizer.

The reverse applies when the parts 2A, 2B are detached, i.e. the valve bodies 8A, 8B are forced against a common plane by the counter bodies 12A, 12B. There is then no space capable of harboring any residual liquid, and leakage into atmosphere is minimal.

The procedure described above provides essentially simultaneous opening of flow paths for liquid in both parts 2A, 2B. The parts can naturally be devised for sequential opening of the flow passages during simultaneous activation of the valve bodies 8A, 8B. All that is necessary is for e.g. the first valve body 8A to have a longer opening path than the second valve body 8B.

Although modifications and changes may be suggested by those skilled in the art, it is the intention of the inventor to embody within the patent warranted hereon all changes and modifications as reasonably and properly come within the scope of his contribution to the art.

I claim as my invention:

1. A coupling system for transferring a volatile liquid from a container to an apparatus in which the volatile liquid is to be used, said coupling system comprising:
a first part comprising a first valve with a first spring-loaded body and a first counter-body.
a second part comprising a second valve with a second spring-loaded valve body and a second counter-body;
said first part and said second part being interconnectable with said first counter-body acting on said second spring-loaded valve body in an opening direction, and said second counter-body acting on said first spring-loaded valve body in said opening direction, to form a flow path for said liquid; and
said first spring-loaded valve body and said first counter-body in a closed position forming a substantially flat first surface, and said second spring-loaded valve body and said second counter-body in a closed position forming a substantially flat second surface, said first surface and said second surface coinciding with each other when said first part and said second part are interconnected.

2. A coupling system as claimed in claim 1 wherein said second part contains a gasket disposed to interact with said first part during interconnection of said first part and said second part before said first surface and said second surface coincide.

3. A coupling system as claimed in claim 1 wherein said second part comprises an adapter designed to fit on said container.
